(19) United States
(12) Patent Application Publication
(10) Pub. No.: US 2018/0144656 A1
(43) Pub. Date: May 24, 2018

(54) EDUCATIONAL CONTENT REVIEW

(71) Applicant: edX Inc., Cambridge, MA (US)

(72) Inventor: Piotr F. Mitros, Cambridge, MA (US)

(21) Appl. No.: 15/817,786

(22) Filed: Nov. 20, 2017

Related U.S. Application Data
(60) Provisional application No. 62/424,010, filed on Nov. 18, 2016.

(51) Int. Cl. G09B 7/04; G09B 5/06; G06Q 50/20

(52) U.S. Cl. CPC G09B 7/04; G06Q 50/20; G09B 5/06

(57) ABSTRACT

A method for maintaining a number of educational certifications includes maintaining a review material data store including storing first review material associated with a first course, the first course having an associated first subject matter, maintaining a review schedule data store including storing a first review schedule for the first course, and maintaining a certificate data store including storing a number of certificates including a first certificate associated with a first user and the first course, and having a number of states, each state of the number of states indicating a capability of the first user in the first subject matter. At least some of the first review material is sent to the first user based at least in part on the first review schedule and a state of the first certificate is updated based on response information characterizing the first user's response to the first review material.

### CROSS REFERENCE TO RELATED APPLICATIONS

This application claims the benefit of, Provisional Application Ser. No. 62/424,010, filed Nov. 18, 2016, the contents of which are hereby entirely incorporated herein by reference.

### BACKGROUND

This invention relates to review of educational content.

“Learning loss” is a concept related to loss of knowledge or skills due to discontinuities or gaps in a student's learning. One example of learning loss due to a gap in a student's learning occurs when a student stops studying over their summer break. One example of a discontinuity in a student's learning occurs when a student achieves a degree and begins a job where at least some of the knowledge or skills obtained during the student's studies are not commonly used. In both cases, unused knowledge or skills are gradually forgotten.

### SUMMARY

Aspects described herein send review content such as brief homework assignments or quizzes to users (e.g., both current and prior students). Users who complete the review content are more likely to retain knowledge and skills over longer periods of time. In some aspects, certificates are maintained for the users, with users who regularly complete review content being granted certificates which indicate that they are up-to-date and users who do not regularly complete review content having their certificates marked as out-of-date.

In a general aspect, a method for maintaining a number of educational certifications includes maintaining a review material data store including storing first review material associated with a first course, the first course having an associated first subject matter, maintaining a review schedule data store including storing a first review schedule for the first course, and maintaining a certificate data store including storing a number of certificates, the number of certificates including a first certificate associated with a first user and the first course, and having a number of states, each state of the number of states indicating a capability of the first user in the first subject matter. At least some of the first review material is sent to the first user based at least in part on the first review schedule and a state of the first certificate is updated based on response information characterizing the first user's response to the first review material.

Aspects may include one or more of the following features.

Updating the state of the first certificate based on the response information may include updating the state of the first certificate to an up-to-date state if the response information indicates that the first user has responded to the at least some of the first review material. Updating the state of the first certificate based on the response information may include updating the state of the first certificate to an out-of-date state if the response information indicates that the first user has not responded to the at least some of the first review material. Updating the state of the first certificate based on the response information may include updating the state of the first certificate to an out-of-date state if the response information indicates that the first user has responded incorrectly to the at least some of the first review material.

The method may include forming the first review schedule including manually specifying one or more review material distribution dates and associating each of the one or more review material distribution dates with a portion of the first review material. Sending the first review material to the first user based at least in part on the first review schedule may include, for each of the one or more review material distribution dates, sending the portion of the first review material associated with the review material distribution date to the first user.

The method may include forming the first review schedule including automatically specifying one or more review material distribution dates and associating each of the one or more review material distribution dates with a portion of the first review material. Automatically specifying the one or more review material distribution dates may include specifying review material distribution dates with a weekly temporal spacing. Automatically specifying the one or more review material distribution dates may include specifying review material distribution dates with a monthly temporal spacing. Automatically specifying the one or more review material distribution dates may include specifying review material distribution dates with an annual temporal spacing. Automatically specifying the one or more review material distribution dates may include specifying review material distribution dates with an exponentially increasing temporal spacing.

Automatically specifying the one or more review material distribution dates may include adapting at least some of the one or more review material distribution dates according to information characterizing a performance of a number of users on previously distributed review material. Adapting the at least some of the one or more review material distribution dates may be further performed according to information characterizing a rate of learning loss. At least some of the first review material may be selected according to an information characterizing a rate of learning loss. The at least some of the first review material may be selected using an approximation algorithm for the set cover problem. The approximation algorithm may include a simulated annealing algorithm. The first review material may include at least some review material that the first user is required to complete.

The first review material may include at least some review material that the first user can optionally complete. The first review material may include at least some review material that the user is required to complete prior to updating the state of the certificate.

In another general aspect, software is stored in a non-transitory form on a computer-readable medium, for maintaining a number of educational certifications. The software includes instructions for causing a computing system to maintain a review material data store including storing a first review material associated with a first course, the first course having an associated first subject matter, maintain a review schedule data store including storing a first review schedule for the first course, and maintain a certificate data store including storing a number of certificates, the number of certificates including a first certificate associated with a first user and the first course, and having a number of states, each state of the number of states indicating a capability of the first user in the first subject matter. At least some of the first review material is sent to the first user based at least in part on the first review schedule and a state of the first certificate is updated based on response information characterizing the first user's response to the first review material.

Aspects may have one or more of the following advantages.

Among other advantages, aspects encourage longer-term engagement with users, resulting in reduced learning loss and promote additional learning (e.g., students take additional courses). To do so, aspects schedule administration of review material, automatically administer review material, and evaluate responses to review material. This is in contrast to conventional massive open online course administration technologies which do not take measures to curb learning loss.

Aspects provide a credible way to manage certifications that users are up-to-date with material that they have previously learned.

Other features and advantages of the invention are apparent from the following description, and from the claims.

### DESCRIPTION OF DRAWINGS

FIG. 1 is a content review system.

FIG. 2 is a course authoring interface.

FIG. 3 is a first scheduling user interface of the course authoring interface of FIG. 2.

FIG. 4 is a second scheduling user interface of the course authoring interface of FIG. 2.

FIG. 5 is the content review system of FIG. 1 including exemplary review content.

FIG. 6 shows the content review system of FIG. 5 transmitting review material to a user.

FIG. 7 shows the content review system of FIG. 5 updating a user's certificate to an ‘out-of-date’ state based on a lack of response from the user.

FIG. 8 shows the content review system of FIG. 5 updating a user's certificate to an ‘up-to-date’ state based on a response from the user.

### DESCRIPTION

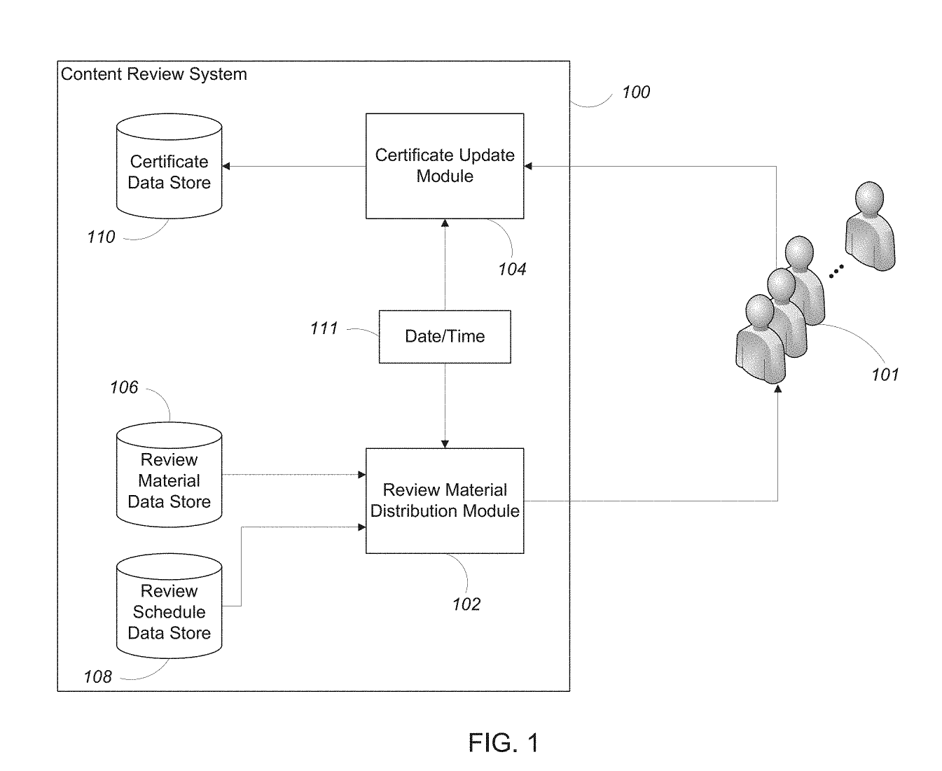

Referring to FIG. 1, a content review system 100 (which may be part of a larger education administration system, not shown) is in communication with a number of users 101 (e.g., students). The content review system 100 includes a review material distribution module 102 and a certificate update module 104. The review material distribution module 102 is in communication with a review material data store 106 and a review schedule data store 108. The certificate update module 104 is in communication with a certificate data store 110. A Date/Time module 111 provides the current date and/or time to the certificate update module 104 and the review material distribution module 102.

The review material data store 106 includes a number of instances of review material for any number of subjects administered by the content review system 100. The types of review material include but are not limited to homework assignments, review examinations, individual review questions, pop quizzes, reading material, multimedia viewing material (e.g., images or video), and so on.

The review schedule data store 108 includes one or more review schedules for administering review content. For example, a review schedule for a calculus course may specify that every week a different review homework assignment is sent to users with the exception that every fourth week a different review examination is sent to the users.

The review material distribution module 102 receives review schedules from the review schedule data store 108 and determines which review material to send to users based on the review schedules and the current date and time. For example, on Jan. 14, 2017 a review schedule for a calculus course may specify that a particular homework assignment is sent to users at 12:30 PM. On Jan. 14, 2017, the review material distribution module 102 processes the review schedule for the calculus course, retrieves the particular homework assignment, and emails the particular homework assignment to the users at 12:30 PM.

In some examples, the review material distribution module 102 maintains a mapping of review material to learning objectives and/or a hierarchy of courses and learning objectives. The mapping is used by the review material distribution module to prevent sending redundant review material to users. For example, a particular instance of calculus based review material (e.g., a review questions) may be used for both a calculus course and a calculus based physics course. This re-use of review material is represented in the mapping maintained by the review material distribution module 102. Prior to distributing review material to a user that has taken both the calculus course and the calculus based physics course, the review material distribution module 102 consults the mapping to ensure that the particular instance of calculus based review material is not distributed to the user redundantly, but rather that there is an efficient use of such material.

This mapping may contain substantial metainformation about how a resource relates to a learning objective. In some examples the metainformation includes a level of difficulty. The level of difficulty may be tagged by instructors, by humans, or by machine using a standard psychometric technique, such as multivariate item response theory. In some examples, the metainformation includes an amount of scaffolding. For example, problem may tell the student what technique to use (“Use conservation of momentum and conservation of energy to derive the final velocities of these particles after a collision”), a student may need to figure it out in a well-known context (“Derive the final velocities of these particles after a collision”), or may be asked to use a problem in an unknown context (“Two bumper cars collide, moving head-on, one travelling twice as fast as the other, in opposite direction. Assuming they have a perfect spring bumper 4 inches wide, which compresses 4 inches, what is the maximum jerk and final velocity?”). In some examples, the meta-information includes an indication of whether a concept is explained/taught (in other words, designed for a learner who has not seen it before), explicitly exercised (in other words, specific to the problem), or implicitly exercised (for example, a physics problem might also require addition, multiplication, and algebra, even if those are not the point of the problem).

In some examples, learning objectives include a hierarchy of which ones contain other concepts (for example, “introductory algebra” contains “the quadratic formula”), as well as which depend on each other (for example, multiplication depends on addition).

Learning objectives may have a particular structure, such as [verb] [noun] [preposition] [noun], where the verb proposition is selected from a short list (e.g. apply/to), and nouns from a much larger list. For example apply/linearity/to/circuits without memory.

In addition, the system may tag learning objectives by importance/priority.

In some examples, in order to help allocate learners time, the system may prioritize for one or more of higher value learning objectives, diversity (e.g. exercise at least something from Algebra), and objectives with high transfer (e.g. applying learning objectives in novel or relevant contexts).

In addition, the system may collect data based on whether students after a given period successfully completed a problem. If they have not, the system may chose to give future students ones of lower difficulty or with more scaffolding. If they have, it may do the reverse

The users receive review material from the review material distribution module 102 (e.g., via email, through a portal associated with the content review system 100, or via the postal service) and at least some of the users 101 complete the review material. When a user completes review material for a course, an indication (e.g., an email or another suitable message) is sent to the certificate update module 104 which updates the user's certificate for the particular course to an ‘up-to-date’ state. Any users who do not complete the review material for a particular course within a predetermined amount of time (e.g., 1 week) will have their certificates for the particular course changed to an out-of-date′ state. In some examples, if the user completes the review material for the particular course at a time after the predetermined amount of time has lapsed, their certificate for the particular course is changed to an ‘up-to-date’ state. In some examples, the user must complete only the most recent incomplete review material to have their certificate changed to an ‘up-to-date’ state. In some examples, the user must complete as many as all of their incomplete review material to have their certificate changed to an ‘up-to-date’ state. The certificate update module 104 stores updated certificates to the certificate data store 110.

In some examples, a user's answers provided in response to review material are scored and the score is used to determine whether the user's certificate is updated to ‘up-to-date’ (i.e., for a passing score) or ‘out-of-date’ (i.e., for a failing score). In some examples, a user's certificate is updated to ‘up-to-date’ if they complete review material, regardless of the user's score for the review material.

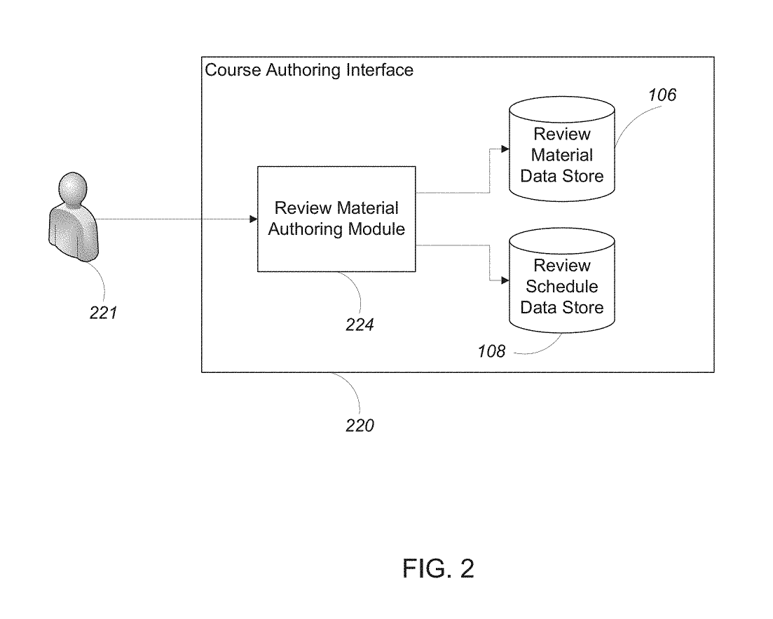

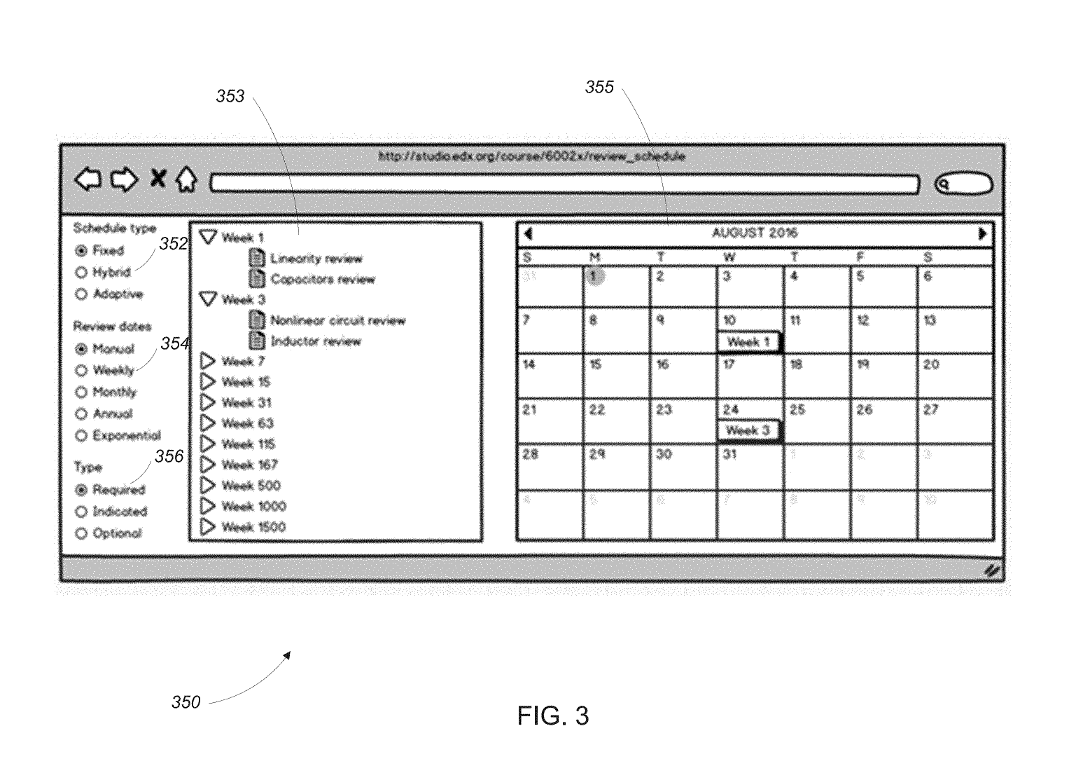

Referring to FIG. 2, a user 221 (e.g., an instructor) interacts with a course authoring interface 220 to author an educational course. Among other modules (not shown), the authoring interface 220 includes a review material authoring module 224 for authoring review material including but not limited to homework assignments, review examinations, individual review questions, pop quizzes, reading material, multimedia viewing material (e.g., images or video), and so on. The user 221 can also author a review schedule for distribution of the review material, rules for maintaining user's certificates, methods of distribution, and other properties. Referring to FIG. 3, one example of a user interface 350 for authoring the review schedule includes a first control 352 for selecting a schedule type, a second control 354 for selecting a review date configuration, and a third control 356 for selecting a review schedule type. The user interface 350 also includes a review material distribution schedule summary view 353 for summarizing a review material distribution schedule, and a calendar view 355 for displaying the review material distribution schedule on a calendar.

In some examples, the first control 352 includes a fixed schedule option, a hybrid schedule option, and an adaptive schedule option. The fixed schedule option indicates any dates that a user specifies for distribution of review material are fixed. In some examples, a fixed review schedule is useful if there is a regulatory concern (e.g., some jobs require annual safety training). For example, an instructor can interact with the user interface 350 to manually specify review distribution dates or to specify that review material is distributed at a fixed interval (e.g., monthly). For each review distribution date, the instructor interacts with the user interface 350 to specify a specific set of training materials associated with that date.

The hybrid schedule option requires the user to specify review material distribution dates, but allows the system to move review material distribution dates. For example, as a rule of thumb, reviews work well when they're as infrequent as possible while still achieving high scores. That is, it's helpful to target reviews just before students forget. Thus, in some examples, the hybrid schedule option allows the system or instructor to specify a threshold (e.g. 80%). The system then distributes review material to sets of students periodically and adaptively adjusts the distribution period based on how long it takes students to reach a given success rate.

For example, the system may periodically distribute review material to a small group of students while adjusting the distribution period based on a percentage of students that pass the review material. In some examples, once the pass rate for a given review distribution period reaches the threshold (e.g., an 80% pass rate), the review material is distributed to all students according to the given review distribution period.

In another example, the system distributes review material to all students on a specified date. If the pass rate for the review material exceeds the threshold, a time period before distributing the next review material to all of the students is increased. If the pass rate for the review material is less than the threshold, a time period before distributing the next review material is decreased.

In another example, the system distributes review material to ½ of the students on a specified date, ¼ of the students a first amount of time earlier than the specified date (e.g., 90% of the review material distribution period), to ⅛ of the students a second amount of time (greater than the first amount of time) earlier than the specified date (e.g., 80% of the review material distribution period), and so on. Success rates of the different groups of students are processed to adjust the review material distribution period.

The adaptive schedule option allows the system to fully adaptively plan out the review distribution schedule, potentially from multiple courses. For example, the instructor selects learning objectives from the course to review. Optionally, the instructor may restrict the set of problems for the system to pick from to a subset of problems, and may give a limit on the amount of time spent on reviews. The system will then choose concepts it determines the student may be starting to forget. In some examples, the system assumes that students forget concepts after a fixed interval (e.g. 6 months), students forget concepts after a growing set of intervals (e.g. 1 month, 3 months, 6 months, 1 year, 2 years, 5 years, 10 years, and then once per decade), or students forget concepts after a growing set of intervals, where such intervals may be adaptively adjusted for all students and problems as per (b), then for individual problems as per (b), and then scaled for individual students (e.g. a student achieving less than 80% pass rate would receive intervals of 50% the duration of other students).

The system chooses a review material covering the largest number of concepts a student has either forgotten, or is at the verge of forgetting, or both. In some examples, the system uses a greedy algorithm to for the review material including repeatedly choosing review problems which covers the largest number of forgotten concepts (or optionally, the largest number of concepts per unit time to solve said problem). The algorithm continues choosing review problems until either some number of review problems is reached, some amount of time is reached, or all concepts are covered.

In some examples, the system uses an approximation algorithm for the set cover problem to for the review material. In some examples, when implementing the approximation algorithm, the constraint that the entire set must be covered to covering a maximal subset at a minimal cost is relaxed. One example of an adequate approximation algorithm is simulated annealing in which a set of n problems is chosen at random. m random elements are then swapped out for p random elements (for random values of m and p) and the result is kept if the optimum improves. m and p are decreased with a standard simulated annealing schedule. The optimized function might be (1 hour−time of problems)*(% of concepts covered).

In some examples, the second control 354 includes a manual review date mode for manually designating review material distribution dates, a weekly review date mode for designating that review material is distributed on a weekly schedule, a monthly review date mode for designating that review material is distributed on a monthly schedule, an annual review date mode for designating that review material is distributed on a yearly schedule, and an exponential review date mode for designating that review material is distributed according to an exponentially increasing schedule.

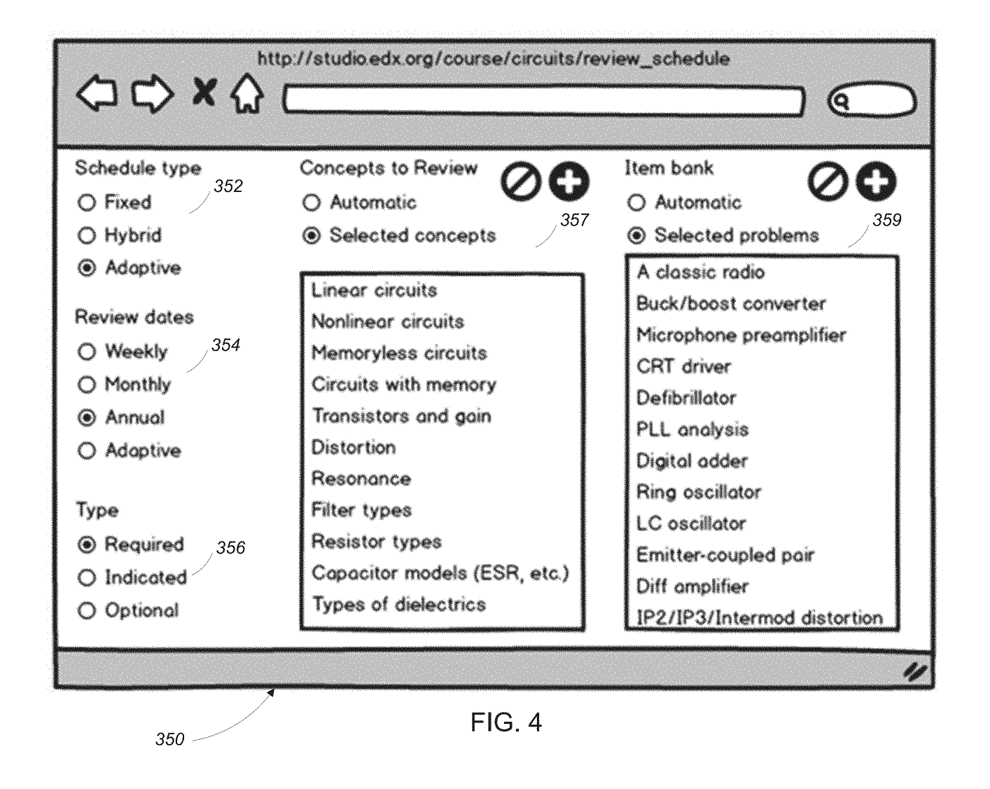

In some examples, the third control 356 includes a required mode, as indicated mode, and an optional mode. Referring to FIG. 4, when the first control 352 is set to the adaptive configuration, the required setting of the third control 356 refers to review material which students must finish (e.g. safety training or legal compliance training where there is a legal obligation to do so annually). The indicated setting refers to review material which has results that are indicated on a certificate. The optional setting refers to review material which is purely for the student's benefit and edification.

The review material generated by the user is stored for later use (e.g., by the review material distribution module 102) in the review material data store 106 and the review schedule generated by the user 221 is stored for later use (e.g., by the review material distribution module 102) in the review schedule data store 108.

In the configuration of FIG. 4, the review material distribution schedule summary view 353 and the calendar view 355 are hidden and are replaced by a concept selection control 357 and a problem selection control 359. The concept selection control 357 allows users to either manually select review concepts for distribution, or to have the system automatically select review concepts based on the concepts covered in the course. The problem selection module allows users to either manually select a pool of specific review problems for distribution, or to have the system automatically select specific review problems for distribution according to the review schedule. The system will then algorithmically select problems such as to maximize concepts, for example, as per the algorithm described in Section 36 [Note: In case bullet numbers change, “In some examples, the system uses an approximation]. The system will modify review schedules as described in Section 30.

### Example

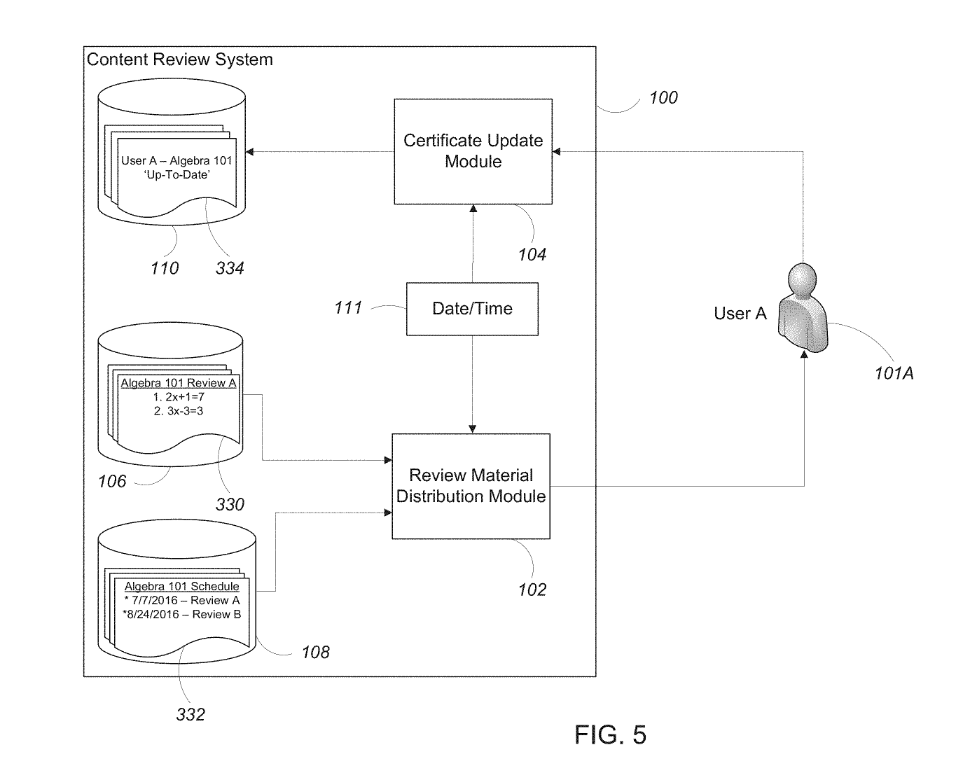

Referring to FIG. 5, in an illustrative example, a user (i.e., User A) 101A interacts with the content review system 100 of FIG. 1. The user 101A has previously completed an Algebra 101 course and the content review system 100 is configured to deliver review material to the user 101A and to maintain a certificate indicating whether the user 101A is ‘up-to-date’ with their algebra skills based on the user's responses to the review material.

The review material data store 106 includes a number of instances of review material including a first review material 330 titled “Algebra 101 Review A” and a second review material (not shown) titled “Algebra 101 Review B.” Both the first review material 330 and the second review material were previously created for the Algebra 101 course by, for example, the instructor for the Algebra 101 course using the course authoring interface 220 of FIG. 2.

The review schedule data store 108 includes a number of review schedules, including a first review schedule 332 for the Algebra 101 course. The first review schedule 332 specifies that “Algebra 101 Review A” is distributed on Jul. 7, 2016 to users that have previously completed the Algebra 101 course and that “Algebra 101 Review B” is distributed on Jul. 7, 2016 to users that have previously completed the “Algebra 101” course.

The certificate data store 110 includes a number of certificates including a first certificate 334 indicating that, at the time instant shown in FIG. 5, the user 101A is ‘up-to-date’ with their algebra skills.

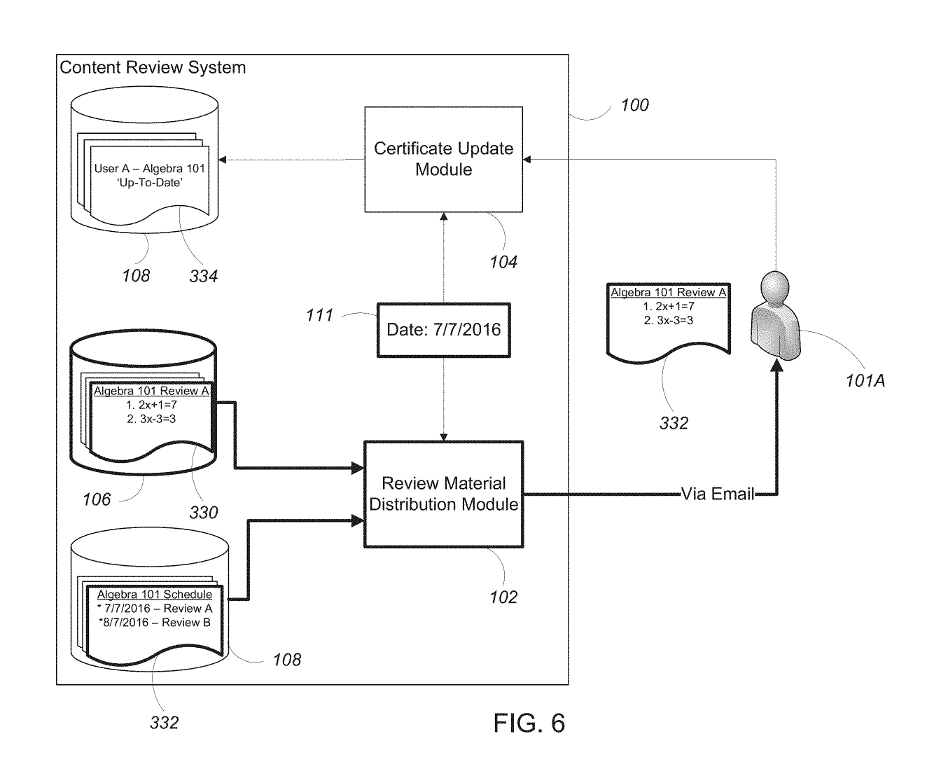

Referring to FIG. 6, when the date provided to the review material distribution module 102 by the date/time module 111 reaches Jul. 7, 2016, the review material distribution module 102 retrieves the first review material 330 and sends the first review material 330 to the user 101A (e.g., via email). The user 101A is given one week from the date of receipt of the first review material 330 to complete the first review material 330, or the first certificate 334 will be marked as ‘out-of-date.’

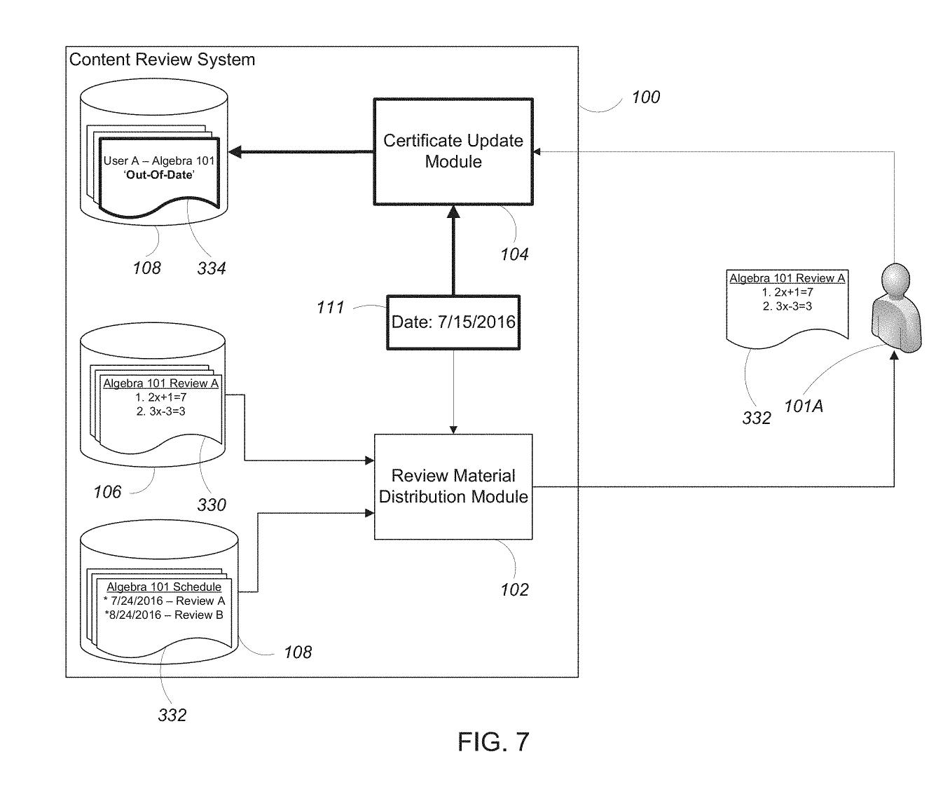

Referring to FIG. 7, after some time has passed, the date/time module 111 provides the date, Jul. 15, 2016 to the certificate update module 104. The certificate update module 104 determines that the user 101A received the first review material 330 over one week ago and marks the first certificate 334 as ‘out-of-date.’

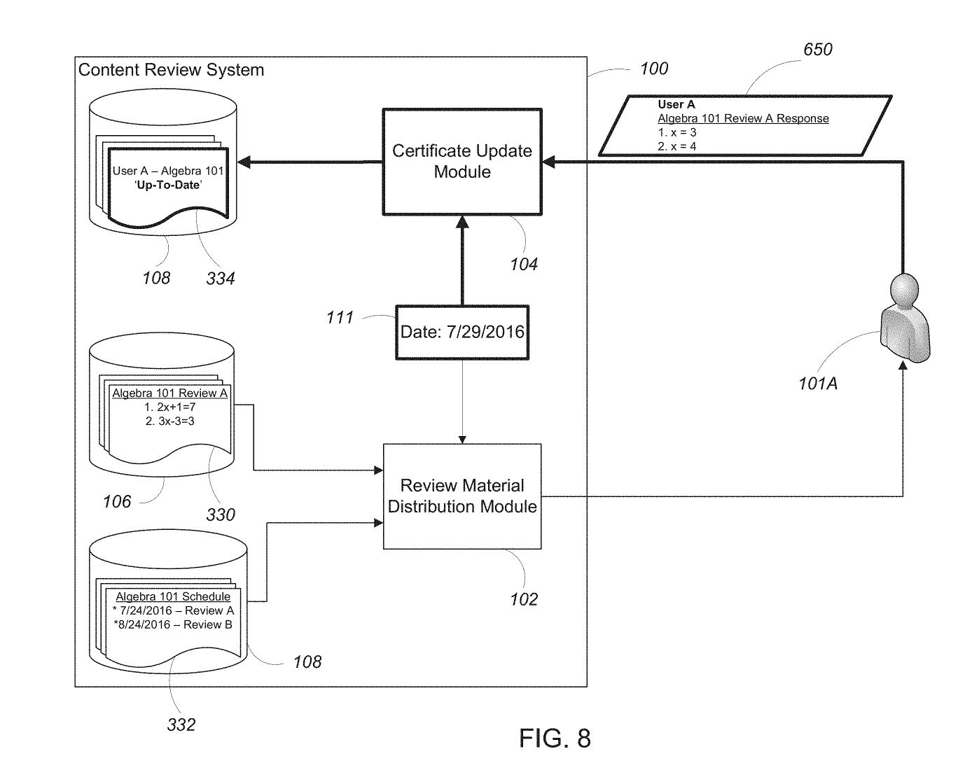

Referring to FIG. 8, after some additional time has passed, the user 101A completes the first review material 330 on Jul. 29, 2016 and sends a representation (e.g., an email) 650 of the completed first review material to the certificate update module 104 of the content review system 100. Based on the representation 650 of the completed review material, the certificate update module 104 determines that the user 101A has completed the first review material 330, accesses the first certificate 330 from the certificate data store 108, and marks the first certificate 334 as ‘up-to-date.’

### Alternatives

In some examples, the certificates maintained by the certificate data store 108 include rich information such as one or more of a degree of capability of a user for subject matter associated with the certificates, an indication of how long the user has been continuously certified or date of original certification, date of last recertification, a name or list of names of certifying entities (and/or URLs there-of), learning objectives related to certificate, a link to the course, a link to an in-depth syllabus of the course, a QR code which allows an entity to verify the certificate online, a cryptographic signature of the key (for example, the system may have a canonical, standardized way to join the name of the course, certifying entity, and student name, as printed on the certificate, for example by joining with a tab delimiter that, in turn, may be cryptographically signed, and the signature embossed on the certificate), a physical signature of the instructors of the course, officials of the school granting the certificate, the organization running the course, and/or the organization proctoring the course, the type of proctoring or monitoring of students during assessments (e.g. in-person test), a portfolio or link to portfolio of projects and/or assignments generated by the student in the course, a final grade in the course, and mastery level on specific learning objectives in the course

While not explicitly shown in the figures, in some examples, the certificate update module 104 receives or is aware of the review schedules stored in the review schedule data store 108.

In some examples, explicit dates are specified in review schedules for delivering content review. In some examples, review intervals (e.g., daily, weekly, monthly, etc.) are specified in review schedules for delivering content review.

In some examples, the approaches described herein are used for content review of courses administered by a massive open online course system (i.e., a MOOC). However, the approaches are also applicable for content review of traditional courses (e.g., university courses, high school courses, or vocational training courses).

### Implementations

Systems that implement the techniques described above can be implemented in software, in firmware, in digital electronic circuitry, or in computer hardware, or in combinations of them. The system can include a computer program product tangibly embodied in a machine-readable storage device for execution by a programmable processor, and method steps can be performed by a programmable processor executing a program of instructions to perform functions by operating on input data and generating output. The system can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Computer programs can implement modules which are software implemented components of a system. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

It is to be understood that the foregoing description is intended to illustrate and not to limit the scope of the invention, which is defined by the scope of the appended claims. Other embodiments are within the scope of the following claims.

What is claimed is:

1. A method for maintaining a plurality of educational certifications, the method comprising:
maintaining a review material data store including storing first review material associated with a first course, the first course having an associated first subject matter;
maintaining a review schedule data store including storing a first review schedule for the first course;
maintaining a certificate data store including storing a plurality of certificates, the plurality of certificates including a first certificate associated with a first user and the first course, and having a plurality of states, each state of the plurality of states indicating a capability of the first user in the first subject matter;
sending at least some of the first review material to the first user based at least in part on the first review schedule;
updating a state of the first certificate based on response information characterizing the first user's response to the first review material.

2. The method of claim 1 wherein updating the state of the first certificate based on the response information includes updating the state of the first certificate to an up-to-date state if the response information indicates that the first user has responded to the at least some of the first review material.

3. The method of claim 1 wherein updating the state of the first certificate based on the response information includes updating the state of the first certificate to an out-of-date state if the response information indicates that the first user has not responded to the at least some of the first review material.

4. The method of claim 1 wherein updating the state of the first certificate based on the response information includes updating the state of the first certificate to an out-of-date state if the response information indicates that the first user has responded incorrectly to the at least some of the first review material.

5. The method of claim 1 further comprising forming the first review schedule including manually specifying one or more review material distribution dates and associating each of the one or more review material distribution dates with a portion of the first review material.

6. The method of claim 5 wherein sending the first review material to the first user based at least in part on the first review schedule includes, for each of the one or more review material distribution dates, sending the portion of the first review material associated with the review material distribution date to the first user.

7. The method of claim 1 further comprising forming the first review schedule including automatically specifying one or more review material distribution dates and associating each of the one or more review material distribution dates with a portion of the first review material.

8. The method of claim 7 wherein automatically specifying the one or more review material distribution dates includes specifying review material distribution dates with a weekly temporal spacing.

9. The method of claim 7 wherein automatically specifying the one or more review material distribution dates includes specifying review material distribution dates with a monthly temporal spacing.

10. The method of claim 7 wherein automatically specifying the one or more review material distribution dates includes specifying review material distribution dates with an annual temporal spacing.

11. The method of claim 7 wherein automatically specifying the one or more review material distribution dates includes specifying review material distribution dates with an exponentially increasing temporal spacing.

12. The method of claim 7 wherein automatically specifying the one or more review material distribution dates includes adapting at least some of the one or more review material distribution dates according to information characterizing a performance of a plurality of users on previously distributed review material.

13. The method of claim 12 wherein adapting the at least some of the one or more review material distribution dates is further performed according to information characterizing a rate of learning loss.

14. The method of claim 1 wherein at least some of the first review material is selected according to an information characterizing a rate of learning loss.

15. The method of claim 14 wherein the at least some of the first review material is selected using an approximation algorithm for the set cover problem.

16. The method of claim 15 wherein the approximation algorithm includes a simulated annealing algorithm.

17. The method of claim 1 wherein the first review material includes at least some review material that the first user is required to complete.

18. The method of claim 1 wherein the first review material includes at least some review material that the first user can optionally complete.

19. The method of claim 1 wherein the first review material includes at least some review material that the user is required to complete prior to updating the state of the certificate.

20. Software stored in a non-transitory form on a computer-readable medium, for maintaining a plurality of educational certifications, the software including instructions for causing a computing system to:
maintain a review material data store including storing a first review material associated with a first course, the first course having an associated first subject matter;
maintain a review schedule data store including storing a first review schedule for the first course;
maintain a certificate data store including storing a plurality of certificates, the plurality of certificates including a first certificate associated with a first user and the first course, and having a plurality of states, each state of the plurality of states indicating a capability of the first user in the first subject matter;
send at least some of the first review material to the first user based at least in part on the first review schedule;
update a state of the first certificate based on response information characterizing the first user's response to the first review material.
